(19) United States
(12) Patent Application Publication
(10) Pub. No.: US 2026/0086299 A1
(43) Pub. Date: Mar. 26, 2026

(54) COUPLER AND ALIGNMENT UNIT FOR OPTICAL POWER TRANSPORT SYSTEM

(71) Applicant: Macleon, LLC, Mobile, AL (US)

(72) Inventors: Edward McKenna, Sebastopol, CA (US); Gerald Leon Wallace, JR., Mobile, AL (US)

(21) Appl. No.: 19/333,796

(22) Filed: Sep. 19, 2025

Related U.S. Application Data
(60) Provisional application No. 63/697,175, filed on Sep. 20, 2024.

(51) Int. Cl. G02B 6/42; H02J 50/30

(52) U.S. Cl. CPC G02B 6/4206; G02B 6/4268; H02J 50/30

(57) ABSTRACT

A coupler assembly is provided for connecting an optical fiber cable to an optical power transport system, the optical fiber cable configured to transport a high power laser beam generated by an optical power source of the system, the coupler assembly comprising: a housing configured to attach to one end of the optical fiber cable; a vacuum chamber formed within the housing and configured to receive the laser beam passing through the coupler assembly; and at least one lens disposed at a first end of the housing and configured to collimate the received laser beam to the vacuum chamber.

### CROSS-REFERENCE

This application claims priority to U.S. Provisional Patent Application No. 63/697,175, filed Sep. 20, 2024, the entire contents of which is incorporated by reference herein.

### TECHNICAL FIELD

This disclosure generally relates to optical power transport systems and more specifically, to a coupler and alignment unit for connecting optical fiber cables to other components of the power transport systems.

### BACKGROUND

Optical fiber cables can be used to transport power from an optical power source to an optical power receiver at a remote endpoint. The term “power over fiber” typically refers to systems in which power generated by an electric power source is converted into optical power using a laser source, which is then transported over an optical fiber cable to an optical detector that converts the optical power back to electrical power and supplies the electrical power to an electric load. As an example, a typical power over fiber system contains a laser diode, a multimode optical fiber made of silica fiber, and a photovoltaic cell or other semiconductor device comprised of materials such as gallium arsenide (GaAs), indium phosphide (InP), or indium gallium arsenide (InGaAs).

Power over fiber systems offer several advantages over typical electrical power systems including, for example, little to no risk of electrical interference, service interruptions due to lightning, and explosions ignited by an electric spark. In addition, optical fiber cables have significantly higher power densities, can tolerate higher temperatures, and are far lighter than electrical cables. Moreover, unlike electrical wires, the same optical fiber may be used to transmit optical power one way and send data back the other way, for example, using a different wavelength or channel. However, implementation of ultra-high power over fiber systems can be prohibitively challenging due to, for example, the precision needed to securely couple and align an optical fiber cable to either end of the transmission system (e.g., optical power source at transmitting end and photodiode detector at receiving end) while avoiding overheating and other thermal performance problems.

Accordingly, there is still a need in the art for a power over fiber system that can efficiently transport ultra-high power across great distances using an optical fiber cable that is safely and securely coupled to each end of the system.

### SUMMARY

The invention is intended to solve the above-noted and other problems through systems, methods, and apparatus configured to provide, among other things, (1) an optical coupler and alignment unit configured to ensure precise alignment and secure coupling of an optical fiber cable to an ultra-high power source or receiver; and (2) a power transport system comprising an optical fiber cable, an optical power source (e.g., ultra-high power laser diode) securely coupled to a first end of the optical fiber cable using a first coupler and alignment unit, and a receiving unit (e.g., photodiode detector) securely coupled to a second end of the optical fiber cable using a second coupler and alignment unit.

One exemplary embodiment provides a coupler assembly for connecting an optical fiber cable to an optical power transport system, the optical fiber cable configured to transport a high power laser beam generated by an optical power source of the system, the coupler assembly comprising: a housing configured to attach to one end of the optical fiber cable; a vacuum chamber formed within the housing and configured to receive the laser beam passing through the coupler assembly; and at least one lens disposed at a first end of the housing and configured to collimate the received laser beam to the vacuum chamber.

Another exemplary embodiment provides an optical power transport system, comprising: an optical power source configured to emit a high power laser beam; an optical detector configured to convert optical energy of the laser beam to electrical energy; an optical fiber cable; and a first coupler assembly configured to connect the optical power source to a first end of the optical fiber cable; a second coupler assembly configured to connect a second, opposing end of the optical fiber cable to the optical detector, wherein each of the first coupler assembly and the second coupler assembly comprises: a housing configured to attach to a select end of the optical fiber cable; a vacuum chamber formed within the housing and configured to receive the laser beam passing through the given coupler assembly; and at least one lens disposed at a first end of the housing and configured to collimate the received laser beam to the vacuum chamber.

As will be appreciated, this disclosure is defined by the appended claims. The description summarizes aspects of the embodiments and should not be used to limit the claims. Other implementations are contemplated in accordance with the techniques described herein, as will be apparent to one having ordinary skill in the art upon examination of the following drawings and detail description, and such implementations are intended to within the scope of this application.

### BRIEF DESCRIPTION OF THE DRAWINGS

For a better understanding of the invention, reference may be made to embodiments shown in the drawings identified below. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals may designate corresponding parts throughout the several views.

FIG. 1 is a functional block diagram illustrating an exemplary power over fiber system comprising an optical fiber cable, in accordance with certain embodiments.

FIG. 2 is a schematic diagram illustrating a cross-sectional view of an exemplary optical fiber cable, in accordance with certain embodiments.

FIG. 3 is a functional block diagram of an exemplary optical power transport system, in accordance with certain embodiments.

FIG. 4 is a schematic diagram of an exemplary coupler and alignment unit, in accordance with certain embodiments.

FIG. 5 is a schematic diagram of another exemplary coupler and alignment unit, in accordance with certain embodiments.

FIG. 6 is a schematic diagram of yet another exemplary coupler and alignment unit, in accordance with certain embodiments.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to "the" object or "a" and "an" object is intended to denote also one of a possible plurality of such objects.

In the following description, elements, circuits and functions may be shown in block diagram form in order to not obscure the present disclosure in unnecessary detail. Additionally, block definitions and partitioning of logic between various blocks is exemplary of a specific embodiment. Further, those of ordinary skill in the art will understand that information and signals as depicted in the block diagrams may be represented using any variety of different technologies or techniques. For example, data, instructions, signals or commends may be represented in the figures, and which also would be understood as representing voltages, currents, electromagnetic waves or magnetic or optical fields, or combinations thereof. Additionally, some drawings may represent signals as a single signal for clarity of the description; and persons skilled in the art would recognize that the signal may represent a bus of signals. Various illustrative logic blocks, modules and circuits described in connection with embodiments disclosed herein may be implemented or performed with one or more processors. As would be appreciated and understood by persons of ordinary skill in the art, disclosure of separate processors in block diagrams may indicate a plurality of processors performing the functions or logic sequence disclosed herein, or may represent multiple functions or sequence performed on a single processor.

Systems, methods, and apparatus described herein provide techniques for a power over fiber system, or optical power transport system, that utilizes optical fiber cable as a transport medium between an optical source included in an electrical to optical conversion unit and an optical detector included in an optical to electrical conversion unit. Various applications for the power over fiber system are contemplated, including optical power transport or distribution systems, and medical or surgical applications. Embodiments include an optical power transport system that uses the optical fiber cable as an interconnector for transporting ultra-high capacity optical power between continents under subsea or submarine conditions (e.g., enough to power a small country). For example, the optical power transport system may be capable of distributing up to 1 gigawatt of power across distances as great as 1000 km at sea level, or 50 km subsea. Other embodiments provide optical power transport systems that use the optical fiber cable to transport power over an electrical grid between distribution stations, to power cellular towers in residential and commercial settings, in power over ethernet (POE) applications, and/or to distribute power in various automotive and aerospace applications.

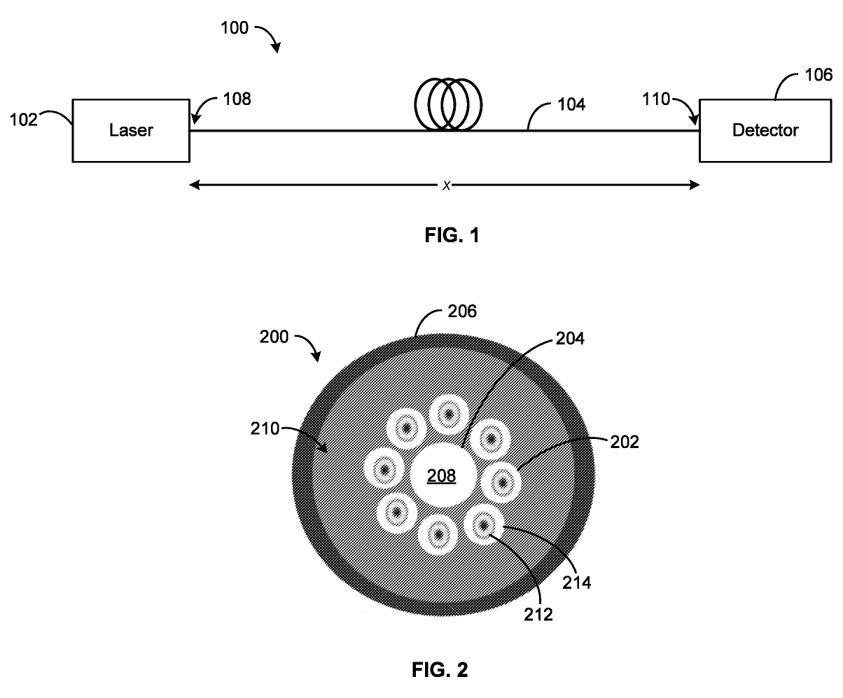

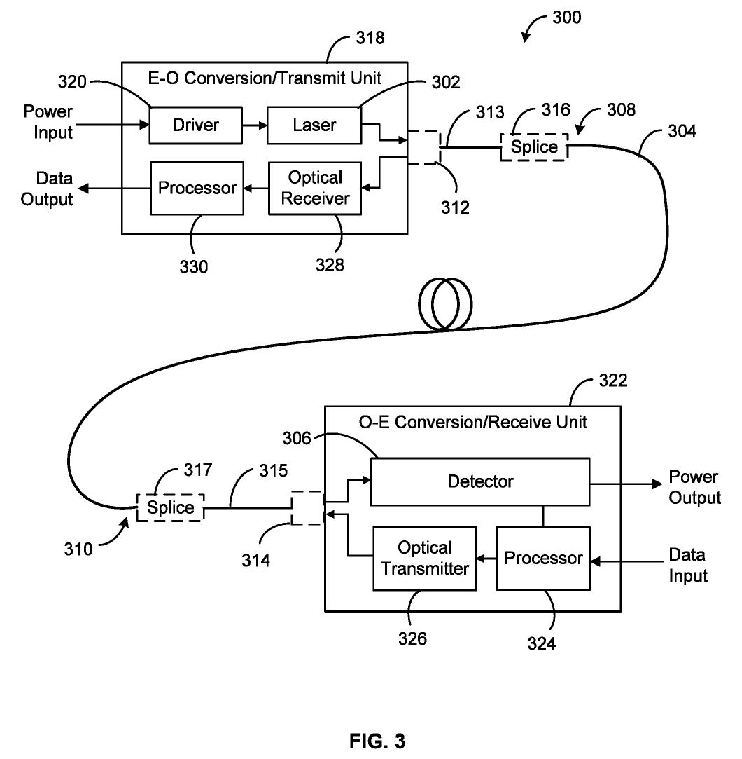

FIG. 1 illustrates an exemplary power over fiber system 100 comprising an optical source 102, an optical fiber cable 104, and an optical detector 106, in accordance with embodiments. As shown, the optical fiber cable 104 comprises a first end 108 coupled to the optical source 102, an opposing second end 110 coupled to the optical detector 106, and a length, x, extending between the first and second ends. In embodiments, each of the optical source 102, the optical fiber cable 104, and the optical detector 106 can be optimally configured to maximize conversion efficiencies, maximize power transport distances, and minimize insertion losses. The power over fiber system 100 may be used in various applications requiring the transport or distribution of optical power between two locations, such as, for example, an optical power transport system, (e.g., as shown in FIG. 3) for commercial, residential, or other uses, a surgical apparatus (not shown), and others.

The optical source 102 comprises one or more laser diodes or other semiconductor devices capable of converting electrical energy into optical energy and emitting the optical energy. In some embodiments, the optical source 102 is part of a larger electrical to optical conversion unit, for example, as shown in FIG. 3. In preferred embodiments, the optical source 102 is a highly efficient laser source capable of emitting ultra-high power laser energy with ultra-low threshold current. As an example, the optical source 102 (also referred to herein as a “laser source”) can include one or more high power laser diode bars (e.g., a GaInAsSb/AlGaAsSb diode) operating at an approximate wavelength of 2.1 microns (µm). As another example, the laser diode in the optical source 102 may be a multi-emitter multimode laser diode with a wavelength of approximately 980 nanometer (nm) and an output power of approximately 420 watts (W), or any other appropriate laser diode. In one embodiment, the optical source 102 has a conversion efficiency of at least about 85 percent and peak power delivery per link of at least about 1 gigawatt (GW). In some embodiments, the optical source 102 comprises a plurality of laser diodes arranged in an array (e.g., a diode array). In such cases, each diode may be individually controllable (e.g., turned on or off) in order alter or control a total output power of the optical source 102. The optical source 102 may further include one or more monitor diodes configured to stabilize an output of the optical source 102 (e.g., prevent fluctuations in laser energy). In some embodiments, the monitor diode of the optical source 102 is further configured to monitor signals received at the optical source 102 from the optical detector 106 (e.g., optical data signals) and provide the signals to a processor (e.g., processor 330 of FIG. 3).

The optical detector 106 comprises a photodiode, a photovoltaic cell, or other semiconductor device capable of detecting laser light or other optical energy and converting the detected light into electrical energy. In some embodiments, the optical detector 106 is part of a larger optical to electrical conversion unit, for example, as shown in FIG. 3. In preferred embodiments, the optical detector 106 comprises one or more highly efficient photodiode detectors (e.g., Four-Junction InGaAs). In one embodiment, the optical detector 106 has a conversion efficiency of at least about 85 percent, a peak power delivery per link of at least about 1 gigawatt (GW), and has a continuous power transmission of approximately one watt (W).

The optical fiber cable 104 serves as a transport medium for carrying optical power from the optical source 102 to the optical detector 106. The optical fiber cable 104 may also be configured to transport data signals, in addition to optical power, for example, as shown in FIG. 3. In preferred embodiments, the optical fiber cable 104 is a ultra-high power cable comprising a plurality of optical fibers bundled together with a cooled center and a thermal acrylic filler surrounding each optical fiber, each fiber extending the length of the cable and comprising ZrF₄-BaF₂-LaF₃-AlF₃-NaF (ZBLAN), or other suitable fluoride glass material. In one embodiment, the optical fiber cable 104 is capable of transmitting laser energy having a power of at least about one gigawatt (GW) over a distance of at least about 1000 kilometers (km) with a loss of about 0.1 decibels (dB) and a power density of 0.4 GW/cm².

FIG. 2 illustrates a cross-sectional view of an exemplary optical fiber cable 200, in accordance with embodiments. The optical fiber cable 200 can be included in the power over fiber system 100 as the optical fiber cable 104, or in any of the other systems described herein. In other embodiments, the optical fiber cable 200 can be configured to transport communication signals over large distances, instead of, or in addition to, optical power.

As shown, the optical fiber cable 200 comprises a plurality of optical fibers 202 disposed radially around a central cooling tube 204 and encased by an outer protective cover 206. According to certain embodiments, the optical fiber cable 200 can comprise any number of fibers 202 selected from a range of approximately 5 to 10 fibers, depending on a desired power capacity and transport distance. In one such embodiment, the optical fiber cable 200 comprises a bundle of eight optical fibers 202 and is capable of transmitting laser energy having a power of at least about one gigawatt (GW) over a distance of at least about 1000 kilometers (km) with a loss of about 0.1 decibels (dB) and a power density of 0.4 GW/cm². In other embodiments, the optical fiber cable 200 comprises up to about 8000 of the optical fibers 202 to accommodate ultra-high capacity power transport needs.

By bundling multiple fibers 202 into one optical fiber cable 200, the cable 200 can be used to alter power distribution to an endpoint, or an electric load coupled thereto, by simply controlling the number of fibers that 202 are used to transport power. In this manner, the transported optical power can be temporarily tailored to the power distribution needs of the electric load.

The cooling tube 204 is configured to increase a power capacity of the cable 200 by countering or dissipating the thermal heat generated by the optical fibers 202 during power transport. For example, the cooling tube 204 can be configured to keep a temperature of the cable 200 below a thermal expansion temperature for ZBLAN fiber, and well below the ZBLAN glass transition temperature (e.g., about 315 degrees Celsius (°C.)). In one example embodiment, the cooling tube 204 is configured to keep or maintain an overall temperature of the cable 200 below 100 °C. In other embodiments, the cooling tube 204 may be configured to maintain cable temperature at or below a different threshold temperature.

According to embodiments, the cooling tube 204 includes a hollow interior filled with a suitable cooling substance, or coolant 208, such as, for example, air or other gas, or an appropriate oil or other liquid. For example, the coolant 208 may include mineral oils or alkylates, such as linear decyl benzene or branched nonyl benzene. In some embodiments, the coolant 208 is cool air, and the two ends of the cooling tube 204 (e.g., at either end of the cable 200) may be kept open to allow cool air to passively follow through the tube 204. In other embodiments, the coolant 208 is a cool air or liquid that is actively pushed through the tube 204 using a coolant management pump (not shown) disposed at one or more ends of the cable 200 (e.g., within the connector). In addition to having cooling properties, the substance 208 may also be configured to maintain a threshold amount of pressure within the cooling tube 204 and thereby, maintain a mechanical integrity of the tube 204. The exact amount of pressure required may vary depending on the number of fibers 202 included in the cable 200, the type of coolant 208, and the environment in which the cable 200 will be used (e.g., undersea or underground).

The cooling tube 204, itself, can be made of aluminum, acrylic, or other suitable material. For example, the cooling tube 204 may be made of aluminum if thicker walls and/or greater mechanical stability is required (e.g., where the cable 200 includes a large number of fibers 202 and therefore, transports lots of power and generates lots of heat). As another example, the cooling tube 204 may be made of acrylic if thinner walls are acceptable (e.g., where the cable 200 includes a small number of fibers 202 and therefore, transports less power and generates less heat). In embodiments where the cable 200 is transporting a low amount of power, the cooling tube 204 may be very small in diameter, or excluded altogether.

The outer protective cover 206 (also referred to as a “protective jacket”) is comprised of Polyurethane (PUR) or Polyvinyl Chloride (PVC) and is configured to protect and insulate the fibers 202 and the cooling tube 204 from external physical forces and chemical deterioration. The protective cover 206 also provides the housing for encasing the interior components of the cable 200. In some embodiments, the outer protective cover 206 comprises multiple layers of materials concentrically arranged and bonded together to form the cover 206.

As shown in FIG. 2, the optical fiber cable 200 further comprises an inner thermal filler 210 disposed between the outer protective cover 206 and the central cooling tube 204 and surrounding each of the optical fibers 202. In embodiments, the thermal filler 210 is configured to maintain a spatial or mechanical integrity of the cable 200 and maintain a consistent temperature throughout the cable 200. For example, by fully surrounding each of the optical fibers 202, the thermal filler 210 isolates or prevents contact between individual fibers 202, which avoids the creation of hot spots if there is thermal build up at one or more of the fibers 202. Moreover, the thermal filler 210 can have a porous structure comprised of pores of different sizes to create variable insulation and structural integrity. As air flows through the pores, heat is transferred or moved throughout the filler 210, thus reducing or preventing thermal build up around select fibers 202. According to embodiments, the thermal filler 210 may be comprised of acrylic (such as, e.g., Polymethyl methacrylate (PMMA)) or other suitable material.

The optical fiber cable 200 has a length extending between a first end and a second end (e.g., length x shown in FIG. 1), and each of the central cooling tube 204, the outer protective cover 206, the inner thermal filler 210, and the plurality of optical fibers 202 extends the length of the cable 200. As such, each of the optical fibers 202 may extend substantially parallel to the central cooling tube 204, and the outer protective cover 206 may be concentrically aligned with the cooling tube 204.

According to embodiments, each optical fiber 202 is a multimode fiber having a fiber core 212 and a cladding 214 disposed around the fiber core 212. The fiber core 212 may be disposed in a center of the cladding 214 and may be fused or bonded to the cladding 214. The core 212 can comprise any suitable fluoride glass material. For example, in embodiments, the core 212 comprises ZrF₄-BaF₂-LaF₃-AlF₃-NaF (ZBLAN) fiber that is drawn in a microgravity environment. The core 212 can be a step index fiber core with a diameter selected to optimize power transport along the length of the fiber 202. In some embodiments, the fiber core 212 has a diameter selected from a range of about 200 µm to about 400 µm. In other embodiments, the fiber core 212 has a diameter selected from a range of about 300 µm to about 500 µm. In one example embodiment, the core diameter is about 600 µm.

The cladding 214 can be configured to confine light within the fiber core 212 by causing total internal reflection at the boundary between the cladding 214 and the core 212. In embodiments, the cladding 214 can be made of a fluoride glass material that is similar to the ZBLAN fiber material but optically different. For example, the cladding 214 may be comprised of a ZBLAN or other fluoride glass material that has a lower refractive index than the refractive index of the fiber core 212. A thickness of the cladding 214 may be selected based on the core diameter, a desired overall diameter for the optical fiber 202, an optimal ratio between the two values for minimizing the thickness of the cladding 214 without comprising light transfer through the fiber 202, and/or a desired amount of flexibility for the overall fiber 202. As an example, in embodiments where the fiber core 212 has a diameter of about 400 µm, the cladding 214 (and therefore, the entire fiber 202) may have a diameter of about 460 µm. And in embodiments where the core diameter is small, the cladding diameter may be proportionally smaller as well.

An overall diameter of the optical fiber cable 200, or a diameter of the outer protective cover 206, can depend on the diameter of each individual fiber 202, the number of fibers 202 included in the cable 200, the diameters of the cooling tube 204 and the thermal filler 210, and/or a thickness of the outer protective cover 206. As an example, in the illustrated embodiment, the optical fiber cable 200 comprises a bundle of eight ZBLAN optical fibers 202, each having a diameter of about 500 microns, with the outer protective cover 206 having a diameter of about five millimeters (mm). Additional details about the construction and configuration of the optical fiber cable 200 may be found in co-owned U.S. Patent No. 11,774,695, the entire contents of which are incorporated by reference herein.

Prior to manufacturing the optical fiber cable 200, the ZBLAN optical fibers 202 are refined or modified using one or more annealing techniques that are configured to remove or reduce imperfections in the ZBLAN core and cladding that create scattering losses, thereby optimizing the fibers 202 for longer transmissions. While conventional methods for refining significant amounts of ZBLAN fiber require traveling to space (e.g., in LEO Satellites or the International Space Station) in order to obtain the requisite low or zero gravity environment, the annealing techniques used to create the optical fiber cable 200 can be performed without leaving Earth or using an aircraft. For example, the optical fiber cable 200 may be refined using one or more of the annealing techniques described in co-owned U.S. Patent Application Nos. 17/581,893 and 17/581,898, filed on Jan. 22, 2022, both of which are incorporated by reference herein in their entirety.

While the optical fibers 202 are described as being a multi-mode fibers, in other embodiments, the optical fiber cable 200 may comprise one or more single mode fibers, instead of, or in addition, multi-mode fibers.

FIG. 3 illustrates an exemplary optical power transport system 300 (also referred to as a “power over fiber system” or a “power distribution system”), in accordance with embodiments. Components of the system 300 may be similar to the power over fiber system 100 shown in FIG. 1. For example, the system 300 comprises an optical source 302 that is substantially similar to the optical source 102 of FIG. 1, an optical fiber cable 304 that is substantially similar to the optical fiber cable 104 of FIG. 1, and an optical detector 306 that is substantially similar to the optical detector 106 shown in FIG. 1. In some embodiments, like the cable 104, the optical fiber cable 304 may have a first end 308 coupled to the optical source 302, a second end 310 coupled to the optical detector 306, and a plurality of optical fibers that extend the length of the cable 304, i.e. the full length between the first end 308 and the second end 310, for example, substantially similar to the ZBLAN optical fibers 202 shown in FIG. 2. For the sake of brevity, the optical detector 306, optical source 302 (also referred to as a “laser source”), and optical fiber cable 304 will not be described in great detail here in light of these similarities.

The optical power transport system 300 can be configured to use the optical fiber cable 304 as a transmission line for transporting optical power, in the form of high power laser energy, to one or more locations or loads. In some embodiments, the optical power transport system 300 can be form, or be part of, an optical fiber network for supplying power to various loads, each load connected to, or including, an optical to electrical converter. For example, the optical fiber network may terminate at various pieces of machinery and equipment in industrial applications, or at various electronics and other devices that are powered using standard wall outlets in residential or commercial applications. In various embodiments, the optical power transport system 300 may be used to distribute power in any industrial, commercial, residential, or personal setting, including, for example, within an airplane, spacecraft, ship, automobile, or home; across great distances (e.g., between continents, countries, cities, etc.); and/or in highly volatile areas, for example, where electrical power distribution may be risky.

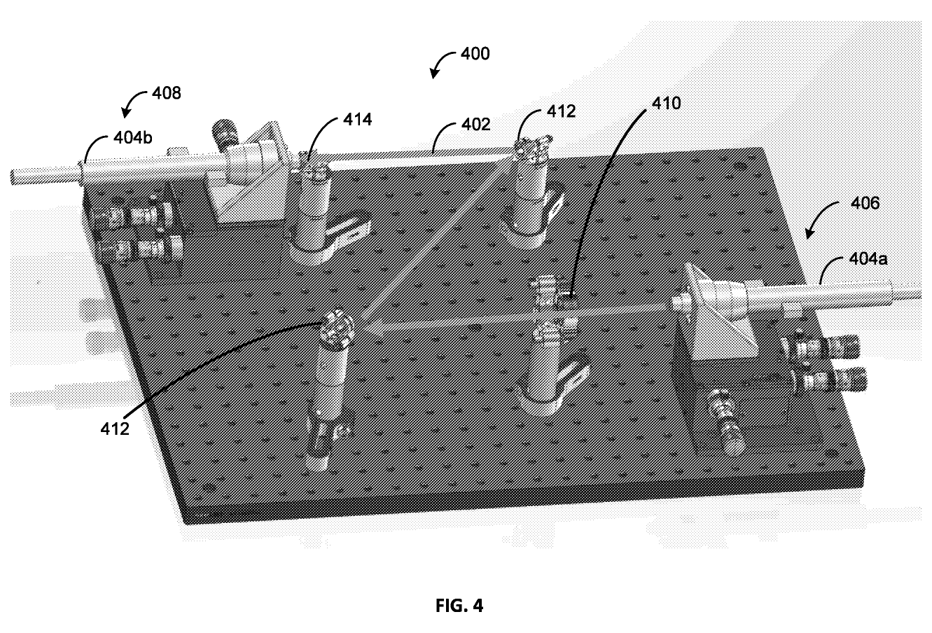

In some embodiments, the ends 308 and 310 of the optical fiber cable 304 may be directly coupled to the optical source 302 and the optical detector 306 via respective fiber optic couplers (or connectors) 312 and 314. As further described herein with respect to FIG. 4, the couplers 312 and 314 may be configured to securely couple and safely align the optical fiber cable 304 with the unit 318/322 coupled thereto, so that the laser beam passes through the coupler 312/314 with minimal distortion or thermal performance issues.

In other embodiments, the system 300 may further include fiber optic splices 316 and/or 317 (e.g., mechanical splice, fusion splice, or any other suitable type of splicing device) that are respectively coupled between the cable 304 and the couplers 312 and 314. For example, as shown in FIG. 3, the first end 308 of the cable 304 may be coupled to a first splice 316, which may be connected to a first connector 312 via a second optical fiber cable 313 that is similar to the optical fiber cable 304. The first connector 312 is also coupled to the optical source 302 and is configured to pass or transmit optical energy or power from the optical source 302 to the optical fiber cables 313 and/or 304. Likewise, the second end 310 of the cable 304 may be coupled to a second splice 317, which may be connected to a second connector 314 via a third optical fiber cable 315 that is similar to the optical fiber cable 304. The second connector 314 is also coupled to the optical detector 306 and is configured to pass the optical power received via the optical fiber cables 315 and/or 304 to the optical detector 306. As will be appreciated, additional splices 316 may be included if more optical fiber cables are joined together in order to deliver power across the power transport system 300.

As shown in FIG. 3, the optical source 302 is included in a transmit unit 318 (also referred to herein as an electrical to optical (“E-O”) conversion unit) and is configured to convert electrical energy into optical energy (e.g., high power laser energy) for transmission over the optical fiber cable 304 (like the optical source 102 of FIG. 1). In embodiments, the electrical energy is electric power received from an external power source (e.g., DC power supply, AC power supply, etc.) coupled to the transmit unit 318. The transmit unit 318 also includes a driver 320 (e.g., laser diode driver) coupled between the power source and the optical source 302 for driving operation of the optical source 302 (e.g., laser diode) with the electrical power signal received from the power source (or other power input). In some embodiments, the transmit unit 318 may be coupled to an external control device (not shown) that serves as an intermediary between the transmit unit 318 and the external power source. In such cases, the external control device may manage the amount of power being supplied to the transmit unit 318 and control other operational aspects of the unit 318.

As shown in FIG. 3, the optical detector 306 is included in a receive unit 322 (also referred to herein as an optical to electrical (“O-E”) conversion unit) and is configured to convert the optical energy (or power) received via the optical fiber cable 304 into electrical energy (or power). In embodiments, the electrical energy is used to power one or more electric loads coupled to the receive unit 322. The electric load(s) may be any type of device or system requiring electrical power, including, for example, a home or building, an electronic device, a power station, a vehicle, and others. Each electric load may be electrically coupled to a respective receive unit 322 using a wired connection (e.g., electric cable or the like) or a wireless connection (e.g., a wireless power transfer system).

In embodiments, the receive unit 322 is also configured to send control signals, status signals, feedback signals, alignment signals, and/or other data signals to the transmit unit 318 via the same optical fiber cable 304 coupled therebetween. The information contained in such data signals may be received from the one or more electric loads coupled to the receive unit 322, or from a control unit (not shown) coupled to multiple electric loads. In such embodiments, the optical fiber cable 304 may include, or may be coupled to, one or more optical circulators (not shown) for enabling bi-directional transmission of optical signals over the cable 304 as a whole, or over one or more of the individual fibers included in the cable 304.

As shown, the receive unit 322 can further comprise a first processor 324 (e.g., microprocessor, microcontroller, or the like) configured to generate one or more digital data signals based on the received information. The receive unit 322 can also include an optical transmitter 326 coupled to the first processor 324 and the optical fiber cable 304. The optical transmitter 326 can be configured to convert the digital data signal into an optical data signal, or other signal suitable for transmission over the optical fiber cable 304 (also referred to herein as an optical status signal (“OSS”)). The optical transmitter 326 can be further configured to provide the optical data signal to the optical fiber cable 304 for transmission to the transmit unit 318. The optical transmitter 326 may be a laser diode (or diode laser) or any other optical device capable of transmitting the optical data signal over the optical fiber cable 304. In some embodiments, the optical transmitter 326 is a laser diode included in the photodiode package of the optical detector 306.

Likewise, the transmit unit 318 can further comprise an optical receiver 328 coupled to the optical fiber cable 304 and a second processor 330 (e.g., microprocessor, microcontroller, or the like) also included in the transmit unit 318. The optical receiver 328 can be configured to receive the optical data signal transmitted over the optical fiber cable 304 and convert the received signal back to digital form. The optical receiver 328 may be a photodiode or other optical device capable of monitoring the optical cavity of the laser diode 302 for the optical data signal. In some embodiments, the optical receiver 328 is a monitor diode integrated into the laser diode package of the optical source 302. The optical receiver 328 can provide the digital data signal to the second processor 330 for processing. In embodiments, the second processor 330 may provide the data extracted from the optical data signal to an external device, such as, for example, a controller or control unit of the external power source. In some embodiments, the optical power transport system 300 may be further configured to implement power regulation techniques based on the optical data signal and a power requirement of the electric load, for example, as described in co-owned U.S. Patent No. 11,656,420, the entire contents of which are incorporated by reference herein.

Referring now to FIG. 4, shown is an exemplary coupler and alignment unit 400 (also referred to herein as a “coupler” or “coupler assembly”) for connecting an optical fiber cable (such as, e.g., optical fiber cable 200 of FIG. 2) to an optical power transport system (such as, e.g., optical power transport system 300 of FIG. 3), in accordance with certain embodiments. The optical fiber cable (not shown in FIG. 4) may be configured to transport a high power laser beam 402 generated by an optical power source (such as, e.g., laser source 302 of FIG. 3) included in the transport system, as described herein. The coupler 400 may be used to securely connect the optical fiber cable to another optical fiber cable, to the optical power source, to a termination end of the power transport system (e.g., optical detector 306 or O-E conversion unit 322 of FIG. 3), or other component of the system (e.g., splices 316 or 317 in FIG. 3). In some embodiments, one or more couplers 400 may be included in the power transport system 300 of FIG. 3 as the fiber optic couplers 312 and 314 for connecting opposite ends of the optical fiber cable 304 to the transmit unit 318 and the receive unit 322, respectively.

As shown, the coupler 400 comprises at least one connector 404 for securely attaching the coupler 400 to a select end of the optical fiber cable, the optical power source, or other component of the transport system. The at least one connector 404 may be a bayonet type fastener or any other suitable mechanical interlock for fixedly positioning and fastening the optical fiber cable to the coupler 400. In the illustrated embodiment, the coupler 400 includes two connectors: a first connector 404a disposed at a first end 406 of the coupler 400 for attaching to a first component of the transport system and a second connector 404b disposed at a second, opposing end 408 of the coupler 400 for attaching to a second component of the system.

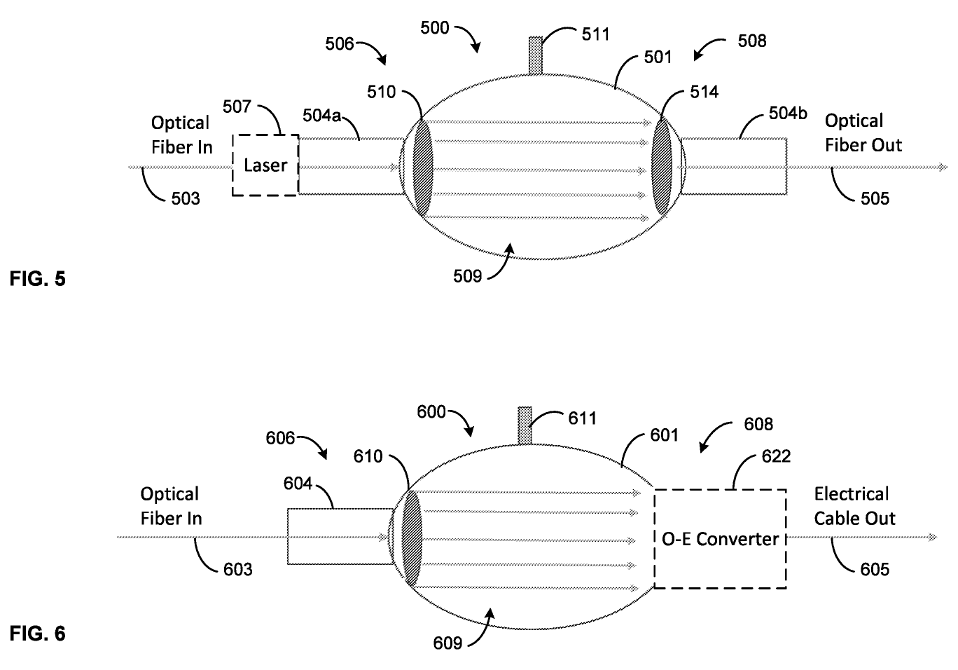

Though not shown, the coupler 400 may further include a housing configured to encase the components of the coupler 400 (e.g., housing 501 shown in FIG. 5). In various embodiments, the housing of the coupler 400 may be configured to have an elongated shape (e.g., cigar-like shape) with the breadboard shown in FIG. 4 removed or reduced to accommodate this shape. In some embodiments, the coupler 400 further comprises one or more electrical contact sensors (not shown) configured to detect whether the connector 404 is securely attached to the optical source or other component and provide a light output or other visual indication when a connection is established.

The coupler 400 also comprises one or more optical elements for optimally manipulating the laser energy that passes through the coupler 400. For example, as shown in FIG. 4, the coupler 400 may include at least one lens 410 disposed at or near the first end 406 of the coupler 400 (a.k.a. the receiving end) for receiving the laser beam 402 that enters the coupler 400 via the first connector 404a. The at least one lens 410, also referred to herein as “collimating lens” or “shaping lens,” can be configured to collimate, focus, or otherwise shape the laser beam 402 so that the beam 402 aligns with, or is parallel to, other internal components of the coupler 400. The at least one lens 410 may be configured to use any suitable technique for collimating and/or shaping the laser beam 402, including, for example, reflection, refraction, diffraction, diffusion, etc.

The optical elements of the coupler 400 may also include one or more mirrors 412 for providing additional beam shaping for the laser beam 402 passing through the coupler 400. For example, the one or more mirrors 412 may be configured to make the laser beam 402 more compact or otherwise easier to align with the component coupled to the output end of the coupler 400 (i.e. the optical fiber cable or termination end of the power transport system). In various embodiments, the one or more mirrors 412 may be Zardur mirrors or any other optical element suitable for shaping the laser beam 402.

In some cases, the first end 406 of the coupler 400 may be coupled to the optical power source, such that the coupler 400 receives the laser beam 402 directly, or nearly directly, from the source (e.g., as shown in FIG. 3), and the second end 408 of the coupler 400 (a.k.a. the transmitting end) may be connected to an input end of the optical fiber cable (e.g., first end 308 shown in FIG. 3). In other cases, the first end 406 of the coupler 400 may be coupled to an output end of the optical fiber cable, and the second end 408 of the coupler 400 may be coupled to an input end of a second optical fiber cable, for example, where two cables are coupled together to extend a reach of the power transport system. In either case, the optical elements of the coupler 400, e.g., the at least one lens 410 and/or the one or more mirrors 412, can be configured to shape the laser beam 402 into an optical mode that matches the mode of the optical fiber cable connected to the second connector 404b.

As shown in FIG. 4, in some embodiments, the coupler 400 may comprise one or more second lenses 414 disposed at or near the second end 408 of the coupler 400 (a.k.a. the emitting end of the coupler 400). The one or more second lenses 414, also referred to herein as “coupling lenses,” may be configured to shape the laser beam 402 as it exits the coupler 400 and couple or focus the laser beam 402 into an input end of the optical fiber cable coupled to the second connector 404b.

In some embodiments, the second end 408 of the coupler 400 may be fixedly attached to, or form part of, a termination end of the power transport system, instead of including the second connector 404b (e.g., as shown in FIG. 6). For example, the first end 406 of the coupler 400 may be coupled to an output end of the optical fiber cable (e.g., second end 310 shown in FIG. 3), and the second end 408 of the coupler 400 may be connected directly to the optical power receiver (e.g., receive unit 322 shown in FIG. 4). In such cases, the optical energy transported by the optical fiber cable and into the coupler 400 may be provided directly to the optical detector for conversion to electrical energy without using the one or more second lenses 414.

Though not shown, in some embodiments, the coupler 400 further includes one or more cooling mechanisms for optimizing a thermal performance of the optical elements located within the path of the laser beam 402. In this manner, the coupler 400 can be configured to keep the optical path through the power transport system clear of any anomalies or other damaging results. For example, even though high power optical power transmission typically has negligible losses, said losses can still cause the optical elements (e.g., collimating lenses, coupling lenses, etc.) within the coupler 400 to heat up to temperatures that are high enough to cause a distortion of the index of refraction, which can result in thermal lensing effects. Cooling the over-heated optical elements may help prevent further damage. Accordingly, various techniques may be used to cool the optical elements shown in FIG. 4 (e.g., elements 410, 412, and/or 414) or otherwise described herein, including, for example, passing oil or cold water (e.g., 14 degrees Celsius) through the mounts that support or hold the optical elements within the path of the laser beam 402, adding cooling fins within the coupler 400, using graphene mounts (or “lens holders”) to hold the optical elements, and/or adding graphene optical elements with central apertures for allowing the laser beam 402 to pass through.

In some embodiments, the coupler 400 may be configured to prevent or reduce over-heating by using lens or optical elements that are made of a material with a higher thermal conductivity than, for example, glass, such as, e.g., diamond, and securing said elements to graphene mounts. For example, in FIG. 4, one or more of the optical elements 410, 412, and 414 may be a diamond lens supported by a lens holder made of graphene. Optical quality diamond may be preferred for high power optical applications because it has the highest thermal conductivity of any presently known material, low absorption over a broad spectrum, and exceptional hardness and strength. Diamond material exhibits other superior qualities as well, including, but not limited to, excellent transparency, resistance to chemical attack, a long wavelength optical window, ability to perform at higher temperatures, and better thermal shock capability compared with other long-wavelength window materials such as zinc sulfide, zinc selenide, and gallium arsenide. Thus, in some embodiments, diamond, or other material with similar optical and thermal properties, may be used to create any of the lenses and/or other optical elements described herein.

In various embodiments, the power transport system may be configured to monitor an alignment of the coupler 400 and the components coupled thereto using a data signal that is transmitted forwards and backwards between the receive unit and the transmit unit of the system in order to identify any misalignments. For example, the data signal may comprise an alignment status of the coupler 400 and may be transmitted along the optical fiber cable 304 between the optical transmitter 326 and the optical receiver 328 of FIG. 3, e.g., similar to the Optical Status Signal (OSS) described herein.

FIG. 5 illustrates another exemplary coupler and alignment unit 500 (referred to herein as a “coupler” or “coupler assembly”) for connecting to an optical fiber cable (e.g., optical fiber cable 200 of FIG. 2) to an optical power transport system (e.g., optical power transport system 300 of FIG. 3), in accordance with certain embodiments. The optical fiber cable may be configured to transport a high power laser beam (e.g., beam 402 of FIG. 4) generated by an optical power source of the system. Operation of the coupler 500 is somewhat similar to the coupler 400 shown in FIG. 4. Accordingly, for the sake of brevity, like numbering is used for like elements and common elements will not be described in great detail below.

As shown, the coupler 500 comprises a housing 501 and at least one connector 504 configured to couple the optical fiber cable to a corresponding end of the housing 501. Like the connector(s) 404, the connector(s) 504 may be a mechanical interlock or other fastening device configured to mechanically and fixedly secure the coupler 500 to the optical fiber cable and/or other component of the power transport system. The exact number of connectors 504 included in the coupler 500 can depend on the placement or functionality of the coupler 500. For example, in some embodiments, the coupler 500 may be used to couple two optical fiber cables together. In such cases, the coupler 500 includes a first connector 504a disposed at a receiving end 506 of the housing 501, the first connector 504a configured to attach to an output end of a first optical fiber cable 503, and a second connector 504b disposed at an emitting end 508 of the housing 501, the second connector 504b configured to attach to an input end of a second optical fiber cable 505, as shown. In other embodiments, the coupler 500 may be used to connect an optical power source 507 (e.g., laser source) to the optical fiber cable 505. In such cases, the coupler 500 may include only the second connector 504b at the emitting end 508 of the housing 501, and the receiving end 506 of the coupler 500 may be attached directly to the optical power source 507, i.e. without the first connector 504a or the first optical fiber cable 503 shown in FIG. 5.

The housing 501 is configured to enclose a transmission line between the two ends 506 and 508 of the coupler 500. The coupler 500 further comprises a vacuum chamber 509 formed within the housing 501 and configured to receive the laser beam passing through the coupler 500, as shown. The vacuum chamber 509 can be configured to prevent contamination and debris from entering the transmission line and disrupting the laser beam. For example, even the smallest dust particles can cause the laser light to scatter and in some cases, ignite.

The vacuum chamber 509 may also be configured to detect faults in mechanical disturbances of the transmission line. For example, the housing 501 and/or the coupler 500 may include one or more sensors configured to monitor a vacuum status of the vacuum chamber 509 and output an alert (e.g., light, sound, etc.) upon detecting a leak in the vacuum chamber 509, or otherwise determining that a true vacuum no longer exists within the vacuum chamber 509. The one or more sensors may include, for example, pressure sensors, optical scattering sensors, or any other suitable sensing device.

In embodiments, the housing 501 is configured to have a rounded shape at each of a first end 506 and an opposing second end 508 of the coupler 500 in order to better facilitate formation and maintenance of the vacuum chamber 509. For example, the housing 501 can have a prolate spheroid shape, or a rounded shape that is elongated in the direction of a central horizontal axis, as shown, or other ellipsoid or rounded shape that is free of sharp edges and thus, optimized to hold a vacuum while withstanding external pressure. The rounded shape of the housing 501 may also provide additional security against structural damage, even in high stress environments (e.g., being run over by a vehicle, etc.).

The vacuum chamber 509 can also improve a thermal management of the coupler 500, as the removal of all air from the chamber 509 ensures that any heat transfer or dissipation of other thermal energy occurs through conduction via the walls of the housing 501, rather than within the chamber 509. As shown, the coupler 500 may further include an evacuation valve 511 coupled to the housing 501 in order to evacuate all air from the chamber 509 during manufacturing. In some embodiments, the evacuation valve 511 may be used to insert an external sensor into the housing 501. In some embodiments, graphene elements or other cooling techniques may be used to further improve the thermal performance of the coupler 500, as described with respect to FIG. 4. For example, the coupler 500 may further include one or more cooling elements disposed within the housing 501 and configured to lower a temperature within the housing 501. In some embodiments, a temperature sensor (not shown) may be included within the housing 501 in order to monitor a temperature of the housing 501 and provide an alert if the housing 501 overheats, or upon detecting a temperature that exceeds a predetermined threshold.

As shown in FIG. 5, the coupler 500 may further comprise one or more optical elements positioned within the vacuum chamber 509 along the high power transmission line. In particular, at least one lens 510 (or “collimating lens”) may be disposed at the first or receiving end 506 of the housing 501, and the at least one lens 510 may be configured to collimate the laser beam to the vacuum chamber, as shown. In some embodiments, the coupler 500 further comprises one or more second lenses 514 (or “coupling lens”) disposed at the second or emitting end 508 of the housing 501 and configured to collimate the laser beam to the input end of the second optical fiber cable 505, as shown. The lenses 510 and 514 may be substantially similar to the lenses 410 and 414, respectively, of FIG. 4. In some embodiments, the housing 501 may further include one or more mirrors (not shown) for additionally shaping the laser beam, similar to the mirrors 412 of FIG. 4. For example, the at least one lens 510 and/or the additional mirrors may be configured to shape an optical mode of the laser beam to match the mode of the second optical fiber cable 505.

FIG. 6 illustrates yet another exemplary coupler and alignment unit 600 (referred to herein as a “coupler”), in accordance with certain embodiments. The coupler 600 may be substantially similar to the coupler 500 of FIG. 5, except a second or emitting end 608 of housing 601 is coupled directly to a termination end of the power transport system, such as, e.g., O-E converter 622 shown in FIG. 6, instead of an optical fiber cable. As a result, the housing 601 includes at least one collimating lens 610 for receiving the laser beam, but does not include a coupling lens like the one or more second lenses 514 shown in FIG. 5. The remaining features and operation of the coupler 600 are substantially similar to that of coupler 500 and thus, will not be described in detail for the sake of brevity.

Any of the computing devices or control units described herein may comprise one or more appropriate hardware devices for carrying out the operations described in association therewith, such as, for example, a processing device (or processor) and a memory device. The processor can be any appropriate hardware device for executing software instructions retrieved from the memory device, such as, for example, a central processing unit (CPU), a semiconductor-based microprocessor (in the form of a microchip or chip set), or another type of microprocessor. The memory device can be any appropriate memory device suitable for storing software instructions, such as, for example, a volatile memory element (e.g., random access memory (RAM, such as DRAM, SRAM, SDRAM, etc.), a nonvolatile memory element (e.g., ROM, hard drive, tape, CDROM, etc.), or any combination thereof. Moreover, the memory device may incorporate electronic, magnetic, optical, and/or other types of storage media. In some embodiments, the memory includes a non-transitory computer readable medium for implementing all or a portion of one or more of the processes described herein. The memory can store one or more executable computer programs or software modules comprising a set of instructions to be performed, such as, for example, one or more software applications that may be executed by the processor to carry out the principles disclosed herein. The executable programs can be implemented in software, firmware, hardware, or a combination thereof.

In certain embodiments, the process descriptions or blocks in the figures can represent modules, segments, or portions of code which include one or more executable instructions for implementing specific logical functions or steps in the process. Any alternate implementations are included within the scope of the embodiments described herein, in which functions may be executed out of order from that shown or discussed, including substantially concurrently or in reverse order, depending on the functionality involved, as would be understood by those having ordinary skill in the art.

It should be emphasized that the above-described embodiments, particularly, any “preferred” embodiments, are possible examples of implementations, merely set forth for a clear understanding of the principles of the invention. Many variations and modifications may be made to the above-described embodiment(s) without substantially departing from the spirit and principles of the techniques described herein. All such modifications are intended to be included herein within the scope of this disclosure and protected by the following claims.

What is claimed is:

1. A coupler assembly for connecting an optical fiber cable to an optical power transport system, the optical fiber cable configured to transport a high power laser beam generated by an optical power source of the system, the coupler assembly comprising:
a housing configured to attach to one end of the optical fiber cable;
a vacuum chamber formed within the housing and configured to receive the laser beam passing through the coupler assembly; and
at least one lens disposed at a first end of the housing and configured to collimate the received laser beam to the vacuum chamber.

2. The coupler assembly of claim 1, wherein the housing has a rounded shape at each of the first end and an opposing second end.

3. The coupler assembly of claim 2, wherein the housing has a prolate spheroid shape.

4. The coupler assembly of claim 1, wherein the first end of the housing is connected to the optical power source.

5. The coupler assembly of claim 1, wherein a second, opposing end of the housing is coupled to the optical fiber cable.

6. The coupler assembly of claim 5, further comprising one or more second lenses disposed at the second end of the housing and configured to collimate the laser beam to an input end of the optical fiber cable.

7. The coupler assembly of claim 1, wherein the first end of the housing is coupled to the optical fiber cable and a second, opposing end of the housing is coupled to a termination end of the power transport system.

8. The coupler assembly of claim 7, wherein the termination end comprises an optical to electrical conversion unit.

9. The coupler assembly of claim 1, wherein the at least one lens is further configured to shape the laser beam to match an optical mode of the optical fiber cable.

10. The coupler assembly of claim 1, wherein the housing further comprises at least one connector configured to securely attach the coupler assembly to the optical fiber cable.

11. The coupler assembly of claim 1, further comprising one or more cooling elements disposed within the housing, the one or more cooling elements configured to lower a temperature within the housing.

12. The coupler assembly of claim 1, further comprising at least one temperature sensor configured to provide an alert upon detecting a temperature within the housing that exceeds a predetermined threshold.

13. The coupler assembly of claim 1, further comprising at least one sensor configured to provide an alert upon detecting a leak within the vacuum chamber.

14. An optical power transport system, comprising:
an optical power source configured to emit a high power laser beam;
an optical detector configured to convert optical energy of the laser beam to electrical energy;
an optical fiber cable configured to transport the high power laser beam; and
a first coupler assembly configured to connect the optical power source to a first end of the optical fiber cable;
a second coupler assembly configured to connect a second, opposing end of the optical fiber cable to the optical detector,
wherein each of the first coupler assembly and the second coupler assembly comprises:
a housing configured to attach to a select end of the optical fiber cable;
a vacuum chamber formed within the housing and configured to receive the laser beam passing through the given coupler assembly; and
at least one lens disposed at a first end of the housing and configured to collimate the received laser beam to the vacuum chamber.

15. The optical power transport system of claim 14, further comprising:
an optical transmitter coupled to the second end of the optical fiber cable and configured to transmit a data signal; and
an optical receiver coupled to the first end of the optical fiber cable and configured to receive the data signal.

16. The optical power transport system of claim 15, wherein the data signal comprises an alignment status of the optical fiber cable.

17. The optical power transport system of claim 14, wherein the housing of each coupler assembly has a rounded shape at each end of the housing.

18. The optical power transport system of claim 14, wherein the at least one lens is further configured to shape the laser beam to match an optical mode of the optical fiber cable.

19. The optical power transport system of claim 14, wherein the optical fiber cable comprises:
a central cooling tube;
a plurality of optical fibers disposed radially around the central cooling tube, each optical fiber comprising a fluoride glass material;
an outer protective cover configured to encase the plurality of optical fibers and the central cooling tube; and
a thermal filler configured to surround each of the plurality of optical fibers, the thermal filler disposed between the outer protective cover and the central cooling tube.

20. The optical power transport system of claim 19, wherein the optical fiber cable is configured to transmit laser energy having a power of at least one gigawatt (GW) over a distance of at least 1000 kilometers (km) with a loss of about 0.1 decibels (dB).
